(19) United States
(12) Patent Application Publication
(10) Pub. No.: US 2009/0003530 A1
(43) Pub. Date: Jan. 1, 2009

(54) Anti-Scatter Grid for an X-Ray Device with Non-Uniform Distance and/or Width of the Lamellae

(75) Inventor: Jozef Cornelis Van Vroonhoven, Nuenen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/096,927

(22) PCT Filed: Nov. 29, 2006
(86) PCT No.: PCT/IB2006/054512

§ 371 Date: Jun. 11, 2008

(30) Foreign Application Priority Data
Dec. 13, 2005 (EP) 05112013.7

(51) Int. Cl. G21K 1/00

(52) U.S. Cl. 378/154

(57) ABSTRACT

An anti-scatter grid (5) for an X-ray device, comprising a plurality of lead lamellae (51) focussed downward and a fixed grid-focus distance (202) and having a filler material (52) therebetween. The width of the lamellae (51) at the edges of the grid (5) is less than that at the centre of the grid (5), and/or the width of the filler material portions (52) is greater at the edges than at the centre of the grid (5). Thus, when the source-to-image distance (SID, 203) varies relative to the grid-focus distance (202), the transmission of the primary radiation beam at the edges of the grid (5) is not adversely affected.

The invention relates to an anti-scatter grid for use in an X-ray device in order to reduce scatter in X-ray images.

It is widely known, in the field of non-invasive medical diagnosis, to obtain a radiation image of a subject to be examined by irradiating the subject with X-radiation and detecting the intensity distribution of the radiation that has been transmitted through the subject.

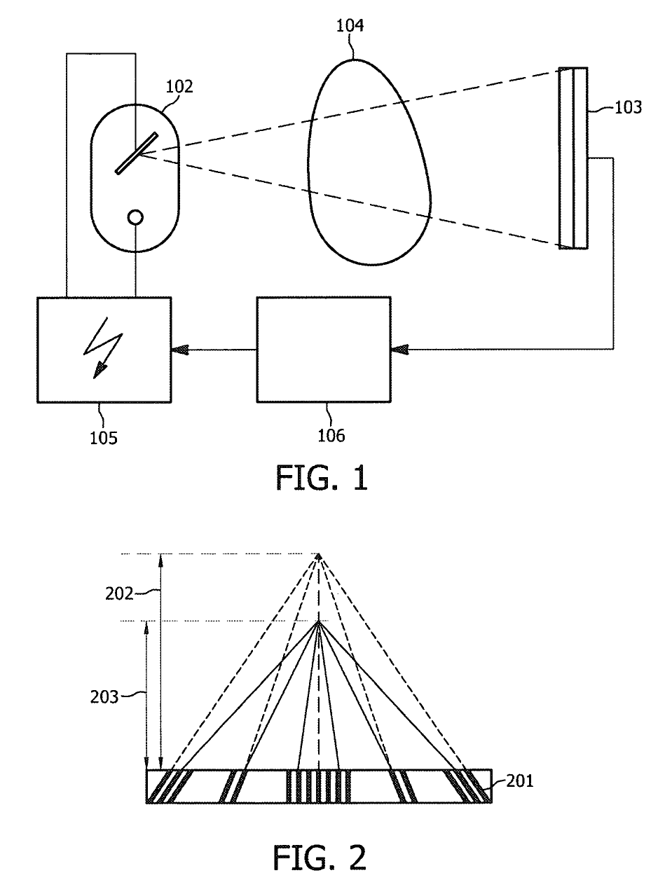

Referring to FIG. 1 of the drawings, there is illustrated schematically a typical X-ray system which comprises an X-ray image detecting sensor unit 103 having a plurality of photoelectric conversion elements. An X-ray source 102, fed by a high voltage generator 105, generates X-rays that are transmitted through a subject 104 to the sensor unit 103. The photoelectric conversion elements of the sensor unit 103 generate an image signal representative of the intensity distribution of the radiation transmitted through the subject 104. The image signal is fed to a digital image processing means within a control unit 106 and the resultant image is then displayed.

Thus, when the subject is irradiated with X-rays, an image signal is generated that is representative of the intensity distribution of primary radiation that has been transmitted through the subject. In addition, however, scattered radiation is also generated which, if it is incident on the sensor unit or detector, it causes a so-called “scatter fog” to be superposed on the resultant X-ray image. Because of this additional exposure, the contrast of the X-ray image will be reduced to an extent that is dependent on the scattered radiation intensity, and the signal to noise ratio of the detail to be imaged is also degraded.

In order to at least reduce the incidence of scattered radiation on the detector, X-ray devices are provided with an anti-scatter grid which is arranged between the subject to be examined and the detector. The function of the anti-scatter grid is to suppress as much scattered radiation as possible, whilst allowing as much primary radiation as possible to be transmitted therethrough to the detector.

A typical anti-scatter grid comprises lead lamellae arranged in rows, with a filling material (e.g. fibre or paper) in between. The filling material should be substantially transparent to X-radiation. Such an anti-scatter grid is described, for example, in U.S. Pat. No. 6,744,852. In a linear grid, the thickness or width w_{L} and height h of the lead lamellae are constant, as are the thickness w_{F} and (same) height h of the filling material in between. Such grids are characterized by the height ratio r=h/w_{F} and the number of line pairs per cm N 10/(w_{L}+w_{F}) and the lead thickness, and these characteristics are used to identify an anti-scatter grid, e.g. a grid known as N60r15 has N=60 lp/cm and ratio=15, meaning that h 2 mm and w_{F}=0.13 mm when w_{L}=0.036 mm.

Referring to FIG. 2 of the drawings, and in order to ensure minimal attenuation of the primary radiation, the lead lamellae 201 are tilted or focussed toward a single central point or line at a distance of, say 100 cm away from the grid, this distance being hereinafter termed the grid-focus distance 202. Thus, the anti-scatter grid is most effective when the source-to-image distance (SID) 203 is equal to the grid-focus distance 202, because the primary X-rays are then minimally attenuated, while the secondary (scattered) X-rays are almost completely attenuated by the lead lamellae 201. In clinical practice, however, the distance (SID) between the source and the detector is often variable relative to the standard SID (=grid-focus distance) and when the SID is not equal to the grid-focus distance, an increase in attenuation of the primary radiation at the edges of the grid occurs, although performance of the grid around its centre is not adversely affected.

It is therefore an object of the present invention to provide an anti-scatter grid with focussed lamellae for use in an X-ray device or the like, wherein the source-to-image distance (SID) can be varied without adversely affecting the performance of the grid.

In accordance with the present invention, there is provided an anti-scatter grid for attenuating scattered radiation incident thereon, said grid comprising a plurality of radiation absorption elements in the form of lamellae arranged in spaced-apart relation, wherein at least some of said lamellae are tilted relative to a vertical axis so as to be focussed toward a single line on a plane at a fixed distance from said grid, and wherein the width of said lamellae at the edges of said grid is less than the width of the lamellae at the centre of the grid.

Thus, the above-mentioned object is achieved by reducing the width of the lamellae at the edges of the grid relative to the width at the centre of the grid and/or increasing the distance between pairs of lamellae at the edges of the grid relative to the distance at the centre of the grid so as to improve transmission of the primary radiation at the edges, even when the source-to-image distance is not equal to the grid-focus distance.

In one exemplary embodiment, the width of the lamellae at the edges of the grid is less than the width of the lamellae at the centre of the grid, and the distance between pairs of lamellae at the edges of the grid is greater than the distance between pairs of lamellae at the centre of the grid. In an alternative exemplary embodiment, the width of the lamellae and the distance between pairs of lamellae are greater at the edges of the grid than those at the centre of the grid, wherein the ratio of the width of the lamellae to the distance between pairs of lamellae is equal to or less than that at the centre of the grid. Preferably, a filler material that is substantially transparent to said radiation is provided between the lamellae. The filler material may, for example, comprise paper, fibre or aluminium. The lamellae may be made of lead, which is highly radiation absorptive even at small thicknesses thereof, or any other highly radiation absorptive material.

Beneficially, the height of the grid is substantially uniform, and defined by the height of the lamellae.

The present invention extends further to an X-ray device comprising a radiation source for generating a radiation beam for transmission through a subject of interest, a detector for receiving radiation transmitted through said subject and an anti-scatter grid as defined above located between said detector and said subject.

These and other aspects of the present invention will be apparent from, and elucidated with reference to, the embodiments described herein.

Embodiments of the present invention will now be described by way of examples only and with reference to the accompanying drawings, in which:

FIG. 1 is a schematic diagram illustrating a typical X-ray system;

FIG. 2 is a schematic diagram illustrating the configuration of a known anti-scatter grid;

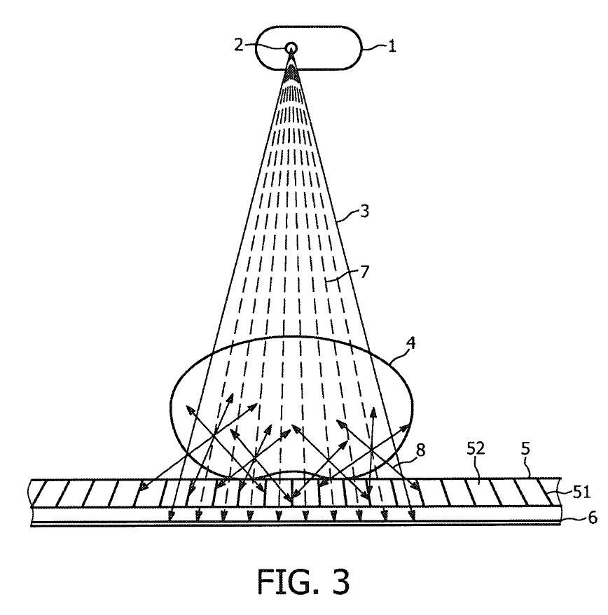

FIG. 3 is a diagrammatic representation of a known X-ray system with an anti-scatter grid;

FIG. 3 is a simplified representation of an X-ray system provided with an anti-scatter grid. An X-ray beam 3 is applied from the focal point 2 of the X-ray tube 1 to a subject 4 to be examined, for example, a patient. The X-rays traversing the subject 4 to be examined are subsequently incident on the anti-scatter grid 5 and the remaining radiation component is ultimately incident on the X-ray detector 6. The anti-scatter grid 5 is composed essentially of absorber laminations or lamellae 51 and a channel medium or filler material 52 which is provided between the lamellae. The lamellae are usually made of lead which has a high absorptivity for X-rays in combination with a small volume, and are directed towards a grid-focus point some distance away from the grid 5 which, in this case, corresponds to focal point 2. The channel medium 52 often consists of fibre, paper or aluminium and transmits X-rays to the highest possible degree.

The anti-scatter grid 5 serves essentially for transmitting the primary radiation 7 traversing the subject 4 to be examined, so that this radiation can be incident on the X-ray detector 6 without any further absorption, whereas scattered radiation 8 produced in the subject 4 to be examined should be suppressed as completely as possible so that it cannot be incident on the X-ray detector 6. As is shown in the Figure, the scattered radiation emanates at various angles from the subject 4 to be examined and is incident on the lamellae 51 in which the scattered radiation 8 is absorbed to a high degree.

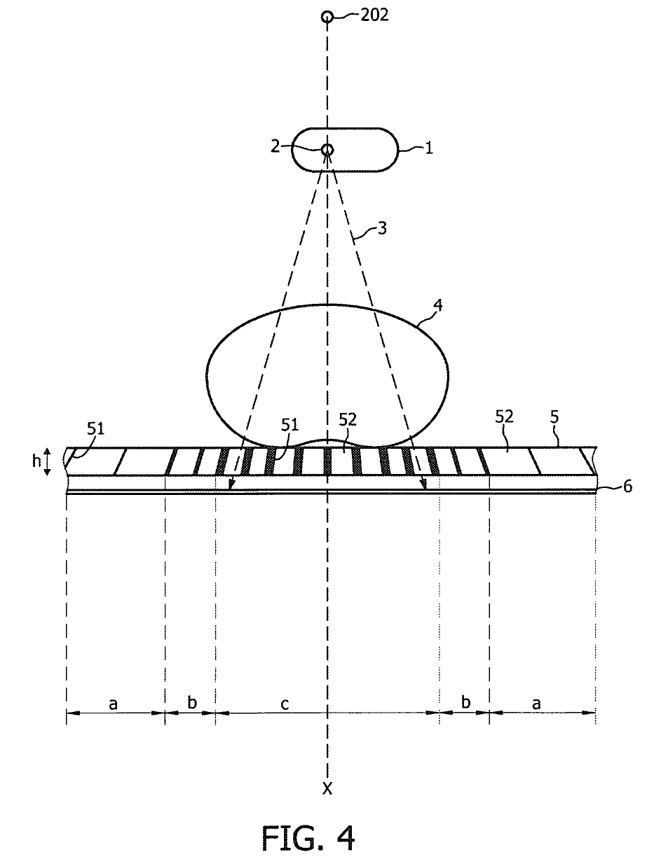

FIG. 4 shows an anti-scatter grid 5 which is constructed in accordance with an exemplary embodiment of the present invention. Consider a linear anti-scatter grid 5 with a central line x, and divided into five sections: a central section (c), intermediate sections (b), and edge sections (a). Of course, the grid may be divided into more or less sections, as required by the application.

All sections have equal grid height h and equal grid-focus distance (defined by the focal point 202 to which the lamellae 51 are directed). However, the thickness or width w_{L} of the lead lamellae 51 and the thickness or width w_{F} of the filler material 52 is different in the intermediate sections (b) and edge sections (a) to that of the central section (c). In the example shown, the lead lamellae width w_{L} is at its greatest in the central section (c), thinner in the intermediate sections (b) and thinner again in the edge sections (a), while the width w_{F} of the channel medium 52 is at its greatest in the edge sections (a), smaller in the intermediate sections (b) and smaller again in the central section (c). However, in an alternative exemplary embodiment, the lead lamellae width w_{L} may get gradually thinner from the central section (c) to the edge sections (a), as shown, but the channel medium width w_{F} may remain constant, or the channel medium width W_{F} may be greater in the edge sections (q) than that in the centre section (c). In yet another exemplary embodiment, the width of the lead lamellae and the channel medium width in the edge sections may be greater than those in the centre section, whilst the channel medium width to lead lamellae width ratio is either constant or greater at the edge section relative to that in the centre section.

Thus, the transmission of the primary radiation beam 3 is improved at the edges of the grid 5 relative to the prior art, even when the source-to-image distance (SID, 203) varies relative to the grid-focus distance 202. Any reduction in suppression of scattered radiation at the edges of the grid 5 is not considered to be a major problem, because the region of interest is mostly in the central part of the X-ray image. In the event that artefacts are caused because the borderlines between adjacent sections of the of grid 5 become visible, such artefacts can be compensated by known image processing techniques.

In the manufacturing process, long strips of single lead/fibre combinations may be glued together, while the grid being made is supported by a concave curved surface, where the surface has radius, say, 100 cm (grid-focus distance 202). The “graded” anti-scatter grid described above according to the present invention can be made by taking different batches of lead/fibre combinations with different lead and/or fibre thicknesses for the respective grid sections.

The anti-scatter grid according to the present invention can be applied to all types of X-ray imaging systems where variable source-to-image distances (SIDs, 203) may occur, ranging from conventional diagnostic equipment to high-end systems for cardiovascular or neurological interventions. Such grids may also be used in, for example, systems for mammography.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. An anti-scatter grid (5) for attenuating scattered radiation (8) incident thereon, said grid (5) comprising a plurality of radiation absorption elements (51) in the form of lamellae arranged in spaced-apart relation, wherein at least some of said lamellae are tilted relative to a vertical axis so as to be focussed toward a single line (202) on a plane at a fixed distance from said grid (5), and wherein the width of said lamellae (51) at the edges of said grid (5) is less than the width of the lamellae at the centre of the grid (5) and/or wherein the distance between pairs of lamellae (51) at the edges of the grid (5) is greater than the distance between pairs of lamellae (51) at the centre of the grid (5).

2. An anti-scatter grid (5) according to claim 1, wherein the distance between pairs of lamellae (51) and the width of the lamellae (51) at the edges of the grid are greater than those at the centre of the grid, and the ratio of the distance between pairs of lamellae (51) to the lamellae width is either substantially uniform or greater at the edges of the grid (5) relative to that at the centre of the grid (5).

3. An anti-scatter grid (5) according to claim 1, wherein a filler material (52) that is substantially transparent to said radiation is provided between the lamellae (51).

4. An anti-scatter grid (5) according to claim 1, wherein the height of the grid (5) is substantially uniform, and defined by the height of the lamellae (51).

5. An X-ray device comprising a radiation source (2) for generating a radiation beam (3) for transmission through a subject (4) of interest, a detector (6) for receiving radiation transmitted through said subject (4) and an anti-scatter grid (5) according to claim 1 located between said detector (6) and said subject (4).
